(19) United States
(12) Patent Application Publication
(10) Pub. No.: US 2012/0011723 A1
(43) Pub. Date: Jan. 19, 2012

(54) Nail Clipper with Reusable Handles and Disposable Blades

(76) Inventor: Shelby Flaten, Dallas, TX (US)

(21) Appl. No.: 12/835,910

(22) Filed: Jul. 14, 2010

(51) Int. Cl. A45D 29/02; B23P 6/00; B23P 11/00

(52) U.S. Cl. 30/28; 30/341; 29/428; 29/402.08

(57) ABSTRACT

The present invention is a nail clipper that comprises a reusable handle assembly and a disposable blade assembly, a method for assembling the nail clipper, and a method for replacing the disposable blade assembly. The handles and the blades are releasably coupled when connector portions on the end of the handles are inserted into cavities in the bases of the blades, where a detent secures the handles to the blades. The handles can be detached from the blades by depressing an actuator lever that forces the detents out of their securing position to allow a new set of disposable blades to be connected to the reusable handles.

### TECHNICAL FIELD

This invention relates to a nail clipper apparatus with reusable handles and disposable blades, a method to assemble such apparatus, and a method for replacing the disposable blades.

### BACKGROUND

Prior art nail clippers have been designed in various forms, including types resembling pliers or shears, types using a compound lever, types using a grip-operated lever, and types designed to stand on a table top. See, e.g., U.S. Pat. Nos. D489,844 (pliers type), 5,701,672 (complex action), 4,644,644 (shear type), 4,176,449 (grip-operated), and 4,564,034 (table top handle).

Some prior art nail clippers disclose removable or replaceable blades or cutting members. See, e.g., U.S. Pat. Nos. 5,331,739, 806,037, and 1,976,067. The blades disclosed in U.S. Pat. Nos. 5,331,739 and 806,037 are formed from one piece of metal that has a loop or is U-shaped. The blades in U.S. Pat. No. 5,331,739 are connected to the handles or arms by snapping a hinge into a notch. The blades in U.S. Pat. No. 806,037 are connected to the handles or arms by “fingers” and are removed by drawing a pin from its place. The cutters disclosed in U.S. Pat. No. 1,976,067 are H-shaped and have two sets of blades, one set for right-hand and one set for left-hand nail-cutting. These prior art nail clippers have disadvantages that are overcome by the present invention.

### SUMMARY

The present invention is a nail clipper having reusable handles and disposable blades that are releasably coupled. One end of each handle includes a connector portion fitted with a detent. The base of each blade has a chamber and an adjacent receiving cavity to hold the detent. The handles and blades can be detached by depressing actuator levers, one on each side of the base of the blades. The levers cause actuator presses to compress the detents into the connector portions, so that the connector portions of the handles can be withdrawn from the blades. Assembly of the handles and blades can be achieved by inserting the connector portion into the chamber. The side walls of the chambers will force the detents to compress into the connector portions until the position of the detents is even with the receiving cavities, and the detents can emerge into the receiving cavities and secure the coupling.

These features reduce replacement costs for a user, who only has to replace the blades instead of the entire nail cutter. Additionally, in a salon setting, the ability to use different blades for different clients provides a hygienic advantage by reducing risks of infection and transmitted diseases. Moreover, the secure fit between the reusable handles and the disposable blades affords great utility to the present novel nail clipper and also affords ease of assembly and disassembly.

The present invention also includes a method for assembling the nail clipper of the present invention and a method for replacing the disposable blades.

### BRIEF DESCRIPTION OF THE DRAWINGS

The apparatus of the invention is further described and explained in relation to the following drawings wherein:

FIG. 1 is a top elevation view of the nail clipper in the closed position;

FIG. 2 is a front elevation view of the nail clipper in the closed position;

FIG. 3 is a side elevation view of the nail clipper in the closed position;

FIG. 4 is a bottom elevation view of the nail clipper in the closed position;

FIG. 5 is a bottom elevation view of the nail clipper in the open position;

FIG. 6 is an exploded top elevation view of the connector portions of the handles and of the disposable blade assembly, including a sectional view of the base of one of the blades;

FIG. 7 is a close-up partial side elevation view of the blade assembly;

FIG. 8 is an exploded top elevation view of the connector portions of the handles and of the disposable blade assembly, including a sectional view of the base of one of the blades; and

FIG. 9 is an exploded top elevation view of the connector portions of the handles and of the disposable blade assembly, including a sectional view of the base of one of the blades.

### DESCRIPTION OF PREFERRED EMBODIMENT

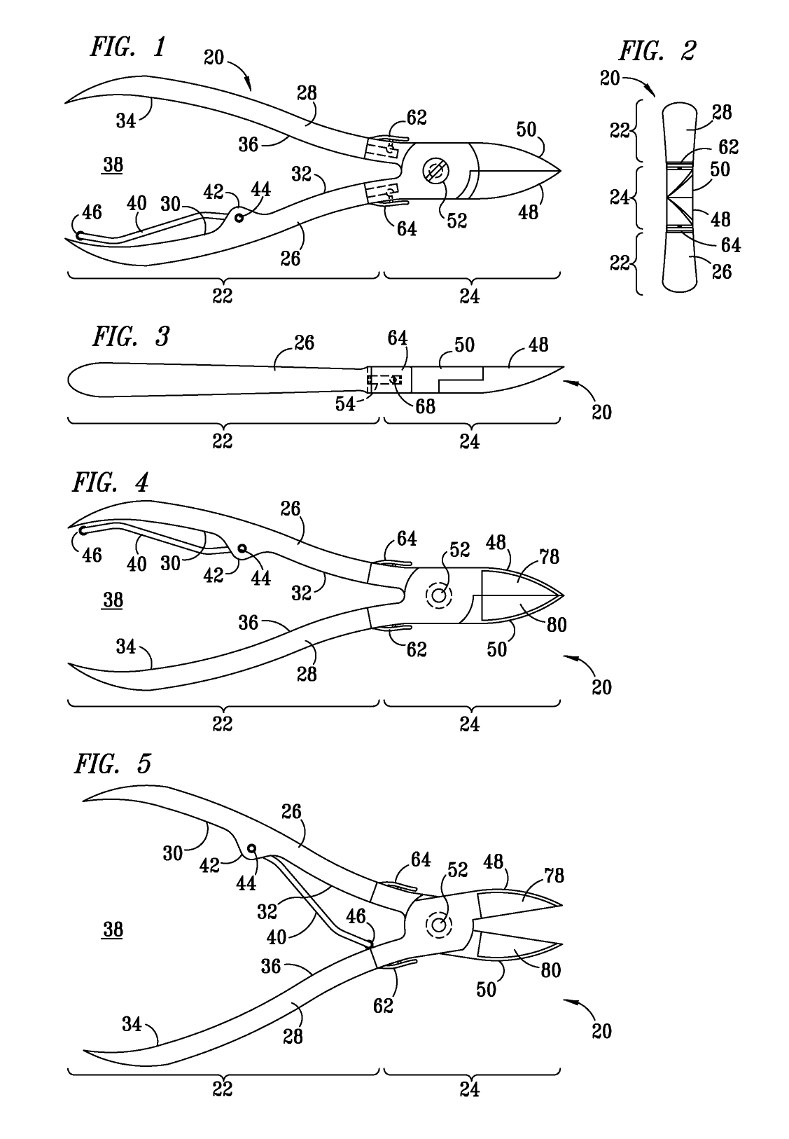

As shown in FIGS. 1-9, the present invention is a nail clipper 20 having a reusable handle assembly 22 and a disposable blade assembly 24. The reusable handle assembly 22 has a first handle 26 and a second handle 28 with a space 38 between them. The inner surface of each handle faces space 38. The inner surface of first handle 26 has a first section 30 and a second section 32. The inner surface of second handle 28 has a first section 34 and a second section 36. Second sections 32 and 36 are proximate to disposable blade assembly 24 while first sections 30 and 34 are further from disposable blade assembly 24, such that second sections 32 and 36 are between first sections 30 and 34 and disposable blade assembly 24.

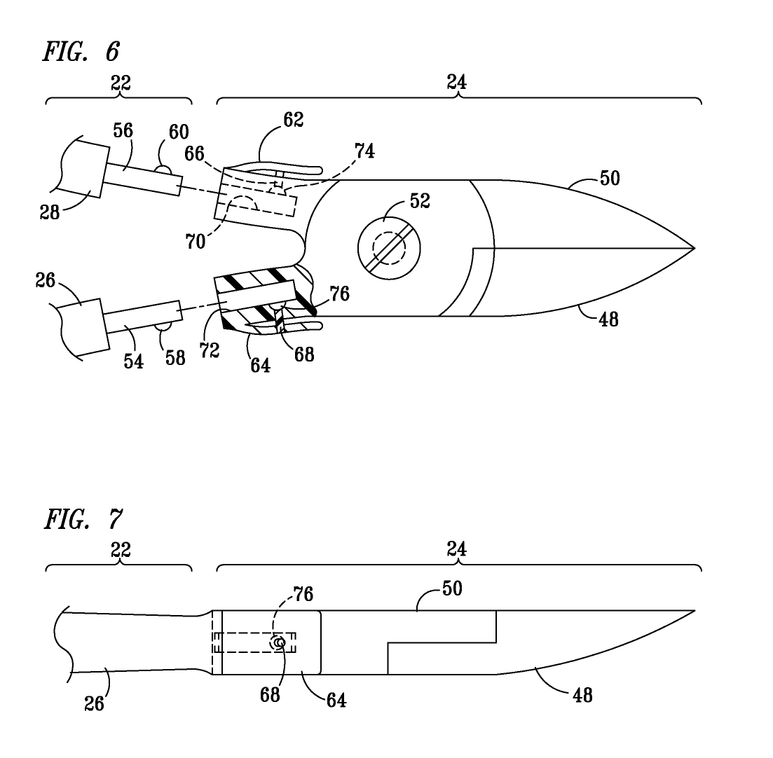

As shown in FIG. 6, at one end of first handle 26 is connector portion 54, and at one end of second handle 28 is connector portion 56. Detent 58 is housed, preferably by being spring-loaded, into the lateral edge of connector portion 54 that is facing away from space 38. Likewise, detent 60 is housed, preferably by being spring-loaded, into the lateral edge of connector portion 56 that is facing away from space 38. Connector portions 54 and 56 are used to releasably couple handles 26 and 28 to disposable blade assembly 24. This novel apparatus affords both great utility and ease of assembly and disassembly.

Nail clipper 20 can be disclosed in a closed position as shown in FIGS. 1-4, 6, and 7-9 or in an open position as shown in FIG. 5. As shown in FIG. 1, on the inner surface of first handle 26, abutment 42 protrudes into space 38 from in between first section 30 and second section 32. Abutment 42 anchors fulcrum 44 upon which spring 40 is mounted and rotates. Spring 40 initially resides in a first position adjacent to first section 30 of the inner surface of first handle 26, which causes nail clipper 20 to be in the closed position as shown in FIGS. 1-4 and 6-9. As shown in FIG. 5, spring 40 can rotate on fulcrum 44 to a second position such that end cap 46 of spring 40 rests on second section 36 of the inner surface of second handle 28. When spring 40 is in this second position, it biases blades 48 and 50 of nail clipper 20 in an open position.

As shown in FIG. 1, attached to handles 26 and 28 is disposable blade assembly 24, which has a first blade 48 and a second blade 50. Blades 48 and 50 are pivotally mounted on pivot pin 52. Blades 48 and 50 can counter-rotate against one another about pin 52. As shown in FIGS. 4 and 5, on one side of the blade, first blade 48 has concave surface 78, and similarly, second blade 50 has concave surface 80. These concave surfaces afford cutting strength and close access of the cutting line to the nail being cut.

As shown in FIG. 6, at the base of first blade 48 is first chamber 70, into which connector portion 56 of second handle 28 is inserted. Adjacent to one lateral edge of first chamber 70 is first receiving cavity 74, which is preferably a semi-circular cavity that receives detent 60. Also as shown in FIG. 6, at the base of second blade 50 is second chamber 72, into which connector portion 54 of first handle 26 is inserted. Adjacent to one lateral edge of second chamber 72 is second receiving cavity 76, which is preferably a semi-circular cavity that receives detent 58. When detents 58 and 60 are set in receiving cavities 76 and 74, respectively, the reusable handle assembly 22 is secured via releasable coupling to disposable blade assembly 24 as shown in FIGS. 1-5 and 7. Although detents 60 and 58 are preferably spherical, they can be of any geometric shape sufficient to afford a secure and releasable fit with corresponding receiving cavities 76 and 74.

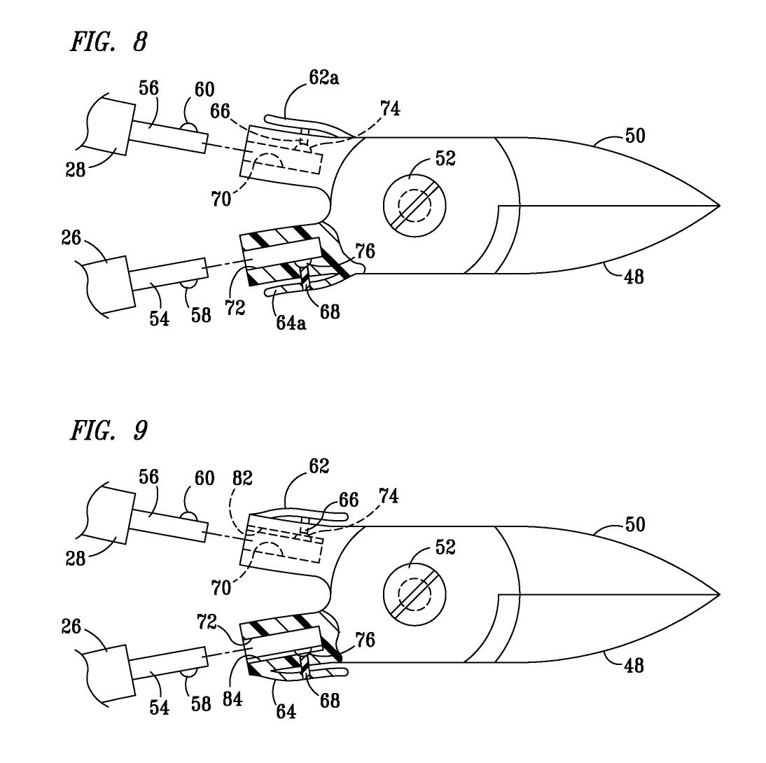

As shown in FIG. 6, on the exterior lateral surface of the base of first blade 48, actuator lever 62 is connected to actuator press 66. Actuator press 66 penetrates through the side of the base of blade 48 and is positioned at first receiving cavity 74. On the exterior lateral surface of the base of second blade 50, actuator lever 64 is connected to actuator press 68 as shown in a partial cross-sectional view in FIG. 6. Actuator press 68 penetrates through the side of the base of blade 48 and is positioned at second receiving cavity 74. As an alternative embodiment shown in FIG. 8, actuator levers 62a and 64a can face toward the handles instead of toward the blades. This embodiment would enable a user to depress the actuator levers without the need to reposition his or her hand on the handles. If a user desires to remove disposable blade assembly 24 from reusable handle assembly 22, then the user may depress actuator lever 62, which causes actuator press 66 to enter first receiving cavity 74 and release detent 60 of connector portion 56, thereby releasing and disengaging the coupling and allowing second handle 28 to be detached from first blade 48. The user may, either simultaneously or in different order, then depress actuator lever 64, which causes actuator press 68 to enter second receiving cavity 76 and release detent 58 of connector portion 54, thereby releasing and disengaging the coupling and allowing first handle 26 to be detached from second blade 50. The user can thus simultaneously depress actuator levers 62 and 64 and quickly remove both handles 26 and 28.

If a user desires to attach a replacement disposable blade assembly 24 to reusable handle assembly 22, connector portions 54 and 56 of handles 26 and 28 are insertable into chambers 70 and 72 of a replacement disposable blade assembly 24. The side walls of the chambers will force detents 58 and 60 to compress into connector portions 54 and 56 until the connector portions have been inserted deep enough into the chambers that the position of the detents is even with receiving cavities 74 and 76. At this point detents 58 and 60 can decompress and emerge into receiving cavities 74 and 76. Once detents 58 and 60 are set into receiving cavities 74 and 76, the coupling between reusable handle assembly 22 and disposable blade assembly 24 is secure. Preferably, the ends of actuator press 66 and 68 are designed to correspond with the shape of detents 58 and 60 as shown in FIGS. 8 and 9. FIG. 8 and FIG. 9 differ in the orientation of actuator levers 62 and 64. Also preferably, as shown in FIG. 9, the side walls of the chambers have guiding grooves 82 and 84 to guide detents 58 and 60 into receiving cavities 74 and 76. The guiding groove provides the user with the ability to insert a handle into a chamber without having to take time to first orient the handles and the blades.

Handles 26 and 28 are preferably manufactured using a durable metal compound, such as steel. Blades 48 and 50 are preferably manufactured using a disposable metal compound or a disposable plastic compound. The type of material used is preferably recyclable.

The present invention also includes a method of assembling nail clipper 20. A user desiring to assemble nail clipper 20 would select reusable handle assembly 22 and would select disposable blade assembly 24. The user would then insert connector portions 54 and 56 of handles 26 and 28 into chambers 70 and 72 at the bases of blades 48 and 50. This step causes detents 58 and 60 to compress into connector portions 54 and 56. The user would then continue to insert connector portions 54 and 56 into chambers 70 and 72 until the position of detents 58 and 60 is even with receiving cavities 74 and 76. At this point detents 58 and 60 decompress and emerge into receiving cavities 74 and 76, thereby securing the coupling between reusable handle assembly 22 and disposable blade assembly 24.

Another aspect of the method is the replacement of disposable blade assembly 24. A user desiring to replace disposable blade assembly 24 would depress actuator levers 62 and 64 to cause the connected actuator presses 66 and 68 to compress detents 58 and 60 into connector portions 54 and 56, thereby releasing the coupling. The user would then withdraw handles 26 and 28 from blades 48 and 50, thereby detaching disposable blade assembly 24 from reusable handle assembly 22. The user would then attach a replacement disposable blade assembly 24 as previously described. Preferably, the user could hold the blade assembly 24 as depicted in FIG. 8 and simultaneously depress actuator levers 62a and 64a so as to afford a fluid method of replacement. Thus, as a user places blade assembly 24 in one hand, the hand simultaneously slips over actuator levers 62a and 64a such that the grasping force both holds the blade assembly 24 and depresses the actuator levers.

1. A nail clipper apparatus comprising:
a reusable handle assembly having a first and a second handle,
each said handle having a connector portion on one end,
each said connector portion having a detent,
a disposable blade assembly having a first and a second blade and a pivot pin,
each said blade having a chamber,
each said chamber having a receiving cavity to receive said detent of said connector-portion of said handle,
each said blade having an actuator lever connected to an actuator press,
wherein said reusable handle assembly is releasably coupled to said disposable blade assembly, such that the depressing of the actuator levers causes the connected actuator presses to enter into the receiving cavities and compress the detents into the connector portions, thereby releasing the coupling and allowing the handles to be detached from the blades.

2. An apparatus as described in claim 1 wherein the detents are spring-loaded.

3. An apparatus as described in claim 1 wherein the detents are spherical in shape.

4. An apparatus as described in claim 1 wherein one side of each blade has a concave surface.

5. An apparatus as described in claim 1 wherein each handle has an inner surface.

6. An apparatus as described in claim 5 wherein a space exists between each handle, and the inner surface of each handle faces said space.

7. An apparatus as described in claim 5 wherein the inner surface of each handle has a first section that is further from the disposable blade assembly, and has a second section that is proximate to the disposable blade assembly.

8. An apparatus as described in claim 7 wherein the first handle has a spring rotatably mounted on a fulcrum that is fixed onto an abutment protruding from the inner surface of the first handle.

9. An apparatus as described in claim 8 wherein the spring has an end cap.

10. An apparatus as described in claim 8 wherein the spring is in a first position lying against the first section of the inner surface of the first handle and can be moved into a second position where it rests on the second section of the inner surface of the second handle, thereby biasing the blades of the apparatus in an open position.

11. An apparatus as described in claim 1 wherein the handles are manufactured from a metal compound.

12. An apparatus as described in claim 1 wherein the handles are manufactured from steel.

13. An apparatus as described in claim 1 wherein the blades are manufactured from a metal compound.

14. An apparatus as described in claim 1 wherein the blades are manufactured from a plastic compound.

15. An apparatus as described in claim 1 wherein the pivot pin is manufactured from a metal compound.

16. An apparatus as described in claim 8 wherein the spring is manufactured from a metal compound.

17. An apparatus as described in claim 8 wherein the spring is manufactured from steel.

18. An apparatus as described in claim 1 wherein each chamber contains a guiding groove to direct the detents into the receiving cavities.

19. A method for assembling a nail clipper comprising the steps of:
selecting a reusable handle assembly having a first and a second handle, wherein,
each said handle has a connector portion on one end, and
each said connector portion has a detent,
selecting a disposable blade assembly having a first and a second blade, wherein,
each said blade has a chamber,
each said chamber has a receiving cavity to receive said detent of said connector-portion of said handle, and
each said blade has an actuator lever connected to an actuator press,
inserting the connector portions of the handles into the chambers at the bases of the blades, thereby causing the detents to compress into the connector portions, and
continuing to insert the connector portions of the handles until the position of the detents is even with the receiving cavities, and the detents can decompress and emerge into the receiving cavities, thereby securing the coupling between the reusable handle assembly and the disposable blade assembly.

20. A method for replacing the disposable blade assembly of a nail clipper comprising the steps of:
selecting a nail clipper with a reusable handle assembly having a first and a second handle and having a disposable blade assembly having a first and a second blade, wherein,
each said handle has a connector portion on one end,
each said connector portion has a detent,
each said blade has a chamber,
each said chamber has a receiving cavity to receive said detent of
said connector-portion of said handle, and
each said blade has an actuator lever connected to an actuator press,
depressing the actuator levers to cause the connected actuator presses to enter into the receiving cavities and compress the detents into the connector portions, thereby releasing the coupling,
withdrawing the handles from the blades, thereby detaching the disposable blade assembly from the reusable handle assembly,
attaching a replacement disposable blade assembly by inserting the connector portions of the handles into the chambers at the bases of the blades causing the detents to compress into the connector portions, and
continuing to insert the connector portions of the handles until the position of the detents is even with the receiving cavities, and the detents can decompress and emerge into the receiving cavities, thereby securing the coupling between the reusable handle assembly and the replacement disposable blade assembly.
